(19) United States
(12) Patent Application Publication
(10) Pub. No.: US 2017/0049276 A1
(43) Pub. Date: Feb. 23, 2017

(54) POWER SYSTEMS FOR DYNAMICALLY CONTROLLING A SOAP, SANITIZER OR LOTION DISPENSER DRIVE MOTOR

(71) Applicant: GOJO Industries, Inc., Akron, OH (US)

(72) Inventors: Bradley L. Lightner, North Canton, OH (US); Mark A. Bullock, Wooster, OH (US)

(21) Appl. No.: 15/241,258

(22) Filed: Aug. 19, 2016

Related U.S. Application Data
(60) Provisional application No. 62/208,098, filed on Aug. 21, 2015.

(51) Int. Cl. A47K 5/12; H02P 7/29; B05B 12/12; B05B 12/08; A47K 5/14; B05B 11/00

(52) U.S. Cl. CPC A47K 5/1217; A47K 5/1211; A47K 5/14; B05B 11/0054; B05B 11/0097; B05B 11/3087; B05B 12/122; B05B 12/081; H02P 7/29

(57) ABSTRACT

Exemplary power systems for dynamically controlling a dispenser drive motor for dispensing soap, sanitizing or lotion. An exemplary soap, sanitizing or lotion dispenser includes a housing, a receptacle for receiving a container for holding a soap, sanitizing or lotion, a container of soap, sanitizing or lotion and a pump secured to the container. The exemplary soap, sanitizing or lotion dispenser includes a power source, a motor and an actuator that couples the motor to the pump. In addition, the exemplary soap, sanitizing or lotion dispenser includes pulse width modulation circuitry in circuit communication with the power source and the motor. Movement of the actuator one actuation cycle dispenses a dose of soap, sanitizing or lotion. The pulse width modulation circuitry provides a plurality of voltage pulses to the motor to move the actuator one actuation cycle.

### RELATED APPLICATIONS

This application claims priority to and the benefits of U.S. Provisional Patent Application Ser. No. 62/208098 filed on Aug. 21, 2015 and entitled “POWER SYSTEMS FOR DYNAMICALLY CONTROLLING A SOAP, SANITIZER OR LOTION DISPENSER DRIVE MOTOR,” which is incorporated herein by reference in its entirety.

### TECHNICAL FIELD

The present invention relates generally to touch free soap and sanitizer dispenser systems and more particularly to power systems for touch free dispensers.

### BACKGROUND OF THE INVENTION

In hands free (or touch free) dispensers, a liquid or foam pump is activated by a drive actuator through a drive cycle to dispense a dose of fluid. The drive actuator is powered by a direct current (DC) motor with a drive train formed of gears or other mechanical means. The drive train (including the motor) strokes or spins the pump. The motor is typically powered by a battery; however, the power source may be an intermediate energy storage device (i.e. capacitors). The power that is delivered to the motor is determined by the motor draw (or load on the motor) and the power capacity of the power source. Batteries deliver power and behave differently than capacitors; hence the motor and drive train will behave differently depending the power source that is providing power. Dispensers typically use a controller or microprocessor that senses motion through a user sensor and sends a signal to a switch device (such as, for example, a power transistor or relay). The switch device connects the power source to the motor for the duration of the actuation cycle. The motor draws power (or current) from the power source as it needs and the power source provides power at whatever level that it can provide. There is no control on the motor speed, motor noise, energy efficiency of the motor or drive train or limiting power delivery from the power source.

### SUMMARY

Exemplary power systems for dynamically controlling a dispenser drive motor for dispensing soap, sanitizing or lotion. An exemplary soap, sanitizing or lotion dispenser includes a housing, a receptacle for receiving a container for holding a soap, sanitizing or lotion, a container of soap, sanitizing or lotion and a pump secured to the container. The exemplary soap, sanitizing or lotion dispenser includes a power source, a motor and an actuator that couples the motor to the pump. In addition, the exemplary soap, sanitizing or lotion dispenser includes pulse width modulation circuitry in circuit communication with the power source and the motor. Movement of the actuator one actuation cycle dispenses a dose of soap, sanitizing or lotion. The pulse width modulation circuitry provides a plurality of voltage pulses to the motor to move the actuator one actuation cycle.

Another exemplary soap, sanitizing or lotion dispenser includes a housing, a receptacle for receiving a container for holding a soap, sanitizing or lotion, a power source, a motor, an actuator coupled to the motor and pulse width modulation circuitry in circuit communication with the power source and the motor. Movement of the actuator one actuation cycle dispenses a dose of soap, sanitizing or lotion. The pulse width modulation circuitry provides a plurality of voltage pulses to the motor to move the actuator one actuation cycle.

Another exemplary soap, sanitizing or lotion dispenser includes a housing, a receptacle for receiving a container for holding a soap, sanitizing or lotion, a power source, a motor; and pulse width modulation circuitry in circuit communication with the power source and the motor. The pulse width modulation circuitry provides a plurality of voltage pulses to the motor to dispense a soap, sanitizing or lotion.

### BRIEF DESCRIPTION OF THE DRAWINGS

These and other features and advantages of the present invention will become better understood with regard to the following description and accompanying drawings in which:

FIG. 1 is a generic illustrative schematic of an exemplary dispenser having a power system that receives dispensing power from a power source inserted and removed with a refill unit;

FIGS. 3 and 4 are exemplary illustrations of pulse width modulated duty cycles;

FIG. 5 is a graph of energy levels verses times for dispense cycles;

FIG. 6 is an exemplary graph of the time differential of a first and a second cycle time for standard dispenser operation and first and second pulse width modulated dispenser cycle times;

FIG. 7 is an exemplary illustration of a DC motor efficiency curve; and

FIG. 8 is an exemplary graph of a load verses displacement curve for a dispenser.

### DETAILED DESCRIPTION

The following includes definitions of exemplary terms used throughout the disclosure. Both singular and plural forms of all terms fall within each meaning. Except where noted otherwise, capitalized and non-capitalized forms of all terms fall within each meaning:

“Circuit communication” as used herein indicates a communicative relationship between devices. Direct electrical, electromagnetic and optical connections and indirect electrical, electromagnetic and optical connections are examples of circuit communication. Two devices are in circuit communication if a signal from one is received by the other, regardless of whether the signal is modified by some other device. For example, two devices separated by one or more of the following—amplifiers, filters, transformers, optoisolators, digital or analog buffers, analog integrators, other electronic circuitry, fiber optic transceivers or satellites -- are in circuit communication if a signal from one is communicated to the other, even though the signal is modified by the intermediate device(s). As another example, an electromagnetic sensor is in circuit communication with a signal if it receives electromagnetic radiation from the signal. As a final example, two devices not directly connected to each other, but both capable of interfacing with a third device, such as, for example, a CPU, are in circuit communication.

Also, as used herein, voltages and values representing digitized voltages are considered to be equivalent for the purposes of this application, and thus the term “voltage” as used herein refers to either a signal, or a value in a processor representing a signal, or a value in a processor determined from a value representing a signal.

“Signal”, as used herein includes, but is not limited to one or more electrical signals, analog or digital signals, one or more computer instructions, a bit or bit stream, or the like.

“Logic,” synonymous with “circuit” as used herein includes, but is not limited to hardware, firmware, software and/or combinations of each to perform a function(s) or an action(s). For example, based on a desired application or needs, logic may include a software controlled microprocessor or microcontroller, discrete logic, such as an application specific integrated circuit (ASIC) or other programmed logic device. Logic may also be fully embodied as software. The circuits identified and described herein may have many different configurations to perform the desired functions.

The values identified in the detailed description are exemplary and they are determined as needed for a particular dispenser and/or refill design. Accordingly, the inventive concepts disclosed and claimed herein are not limited to the particular values or ranges of values used to describe the embodiments disclosed herein.

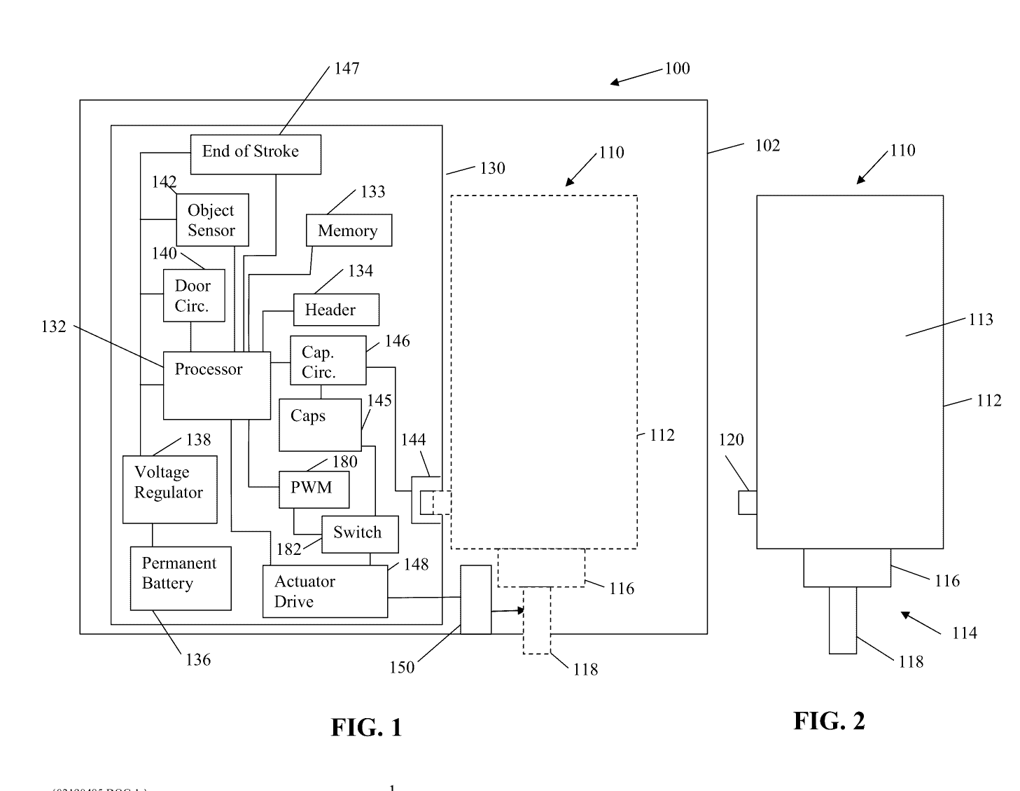

FIG. 1 illustrates a dispenser 100 having an exemplary inventive power system. Dispenser 100 includes a housing 102. Located within housing 102 is system circuitry 130. System circuitry 130 may be on a single circuit board or may be on multiple circuit boards. In addition, some of the circuitry may not be on a circuit board, but rather individually mounted and electrically connected to the other components as required. In this embodiment, system circuitry 130 includes a processor 132, memory 133, a header 134, a permanent power source 136, a voltage regulator 138, door switch circuitry 140, an object sensor 142, end of stroke circuitry 147, actuator drive circuitry 148, a bank of capacitors 145, capacitor control circuitry 146, replaceable power source interface receptacle 144, pulse with modulation circuitry 180 and switching device 182.

Processor 132 may be any type of processor, such as, for example, a microprocessor or microcontroller, discrete logic, such as an application specific integrated circuit (ASIC), other programmed logic device or the like. Processor 132 is in circuit communication with header 134. Header 134 is a circuit connection port that allows a user to connect to system circuitry 130 to program the circuitry, run diagnostics on the circuitry and/or retrieve information from the circuitry. In some embodiments, header 134 includes wireless transmitting/receiving circuitry, such as for example, wireless RF, BlueTooth®, ANT®, or the like, configured to allow the above identified features to be conducted remotely.

Processor 132 is in circuit communication with memory 133. Memory 133 may be any type of memory, such as, for example, Random Access Memory (RAM); Read Only Memory (ROM); programmable read-only memory (PROM), electrically programmable read-only memory (EPROM), electrically erasable programmable read-only memory (EEPROM), flash, magnetic disk or tape, optically readable mediums including CD-ROM and DVD-ROM, or the like, or combinations of different types of memory. In some embodiments, the memory 133 is separate from the processor 132, and in some embodiments, the memory 133 resides on or within processor 132.

A permanent power source 136, such as, for example, one or more batteries, is also provided. The permanent power source 136 is preferably designed so that the permanent power source 136 does not need to be replaced for the life of the dispenser 100. The permanent power source 136 is in circuit communication with voltage regulator circuitry 138. In one exemplary embodiment, voltage regulator circuitry 138 provides regulated power to processor 132, object sensor 142, end of stroke detection circuitry 147 and door circuitry 140. Permanent power source 136 may be used to provide power to other circuitry that requires a small amount of power and will not drain the permanent power source 136 prematurely.

Processor 132 is in circuit communication with door circuitry 140 so that processor 132 knows when the dispenser 100 door (not shown) is closed. In some embodiments, processor 132 will not allow the dispenser 100 to dispense a dose of fluid if the door is open. Door circuitry 140 may be any type of circuitry, such as, for example, a mechanical switch, a magnetic switch, a proximity switch or the like. Processor 132 is also in circuit communication with an object sensor 142 for detecting whether an object is present in the dispense area. Object sensor 142 may be any type of passive or active object sensor, such as, for example, an infrared sensor and detector, a proximity sensor, an imaging sensor, a thermal sensor or the like.

In addition, processor 132 is in circuit communication with pulse width modulation circuitry 180. Pulse width modulation circuitry 180 is in circuit communication with switching device 182. Switching device 182 is in circuit communication with capacitor bank 145 and actuator drive circuitry 148. During operation, processor 132 provides signals to pulse width modulation circuitry 180, which cause pulse width circuitry 180 to control switching device 182 to modulate the power provided by caps 145 to drive the actuator drive 148 (which includes a motor). More detailed descriptions of the modulated are described below.

Actuator drive circuitry 148 causes a motor and associated gearing 150 to operate foam pump 114 (which may be a liquid pump in some embodiments) located on a refill unit 110. In addition, end of stroke detection circuitry 147 is in circuit communication with processor 132 and provides processor 132 with information relating to the end of stroke for the pump 114 so that the processor 132 can determine when to stop the motor and associated gearing. The end of stroke circuitry 147 may include, for example, an encoder, a physical switch, a magnetic switch, software algorithm or the like.

In this exemplary embodiment, refill unit 110 is shown in phantom lines inserted in the dispenser 100 in FIG. 1 and is also illustrated in solid lines in FIG. 2. Thus, this illustrates that refill unit 110 is inserted into dispenser 100 and removed from dispenser 100 as a unit. Refill unit 110 includes a container 112, a foam pump 114 that includes an air compressor 116 and an outlet 118. In some embodiments, refill unit 110 includes a container and a liquid pump and mates with a permanent air compressor (not shown) located in housing 102 to produce a foam product. Refill unit 110 also includes a foamable liquid 113, such as, for example, a foamable soap, sanitizer, lotion, moisturizer or other liquid used for personal hygiene. In some embodiments, refill unit 110 is for use in a liquid dispenser, rather than a foam dispenser, and filled with liquid that is not foamed. Accordingly, air compressor 116 is not required.

In addition, refill unit 110 includes a replaceable power source 120. Replaceable power source 120 may be any power source, such as, for example, a single “AA” battery, a coin cell battery, a 9 volt battery or the like. In some embodiments, the replaceable power source 120 does not contain enough power to directly power motor and associated gearing 150 to dispense the contents of the refill unit 110. Replaceable power source 120 is inserted into dispenser 100 with refill unit 110 and is removed from dispenser 100 with refill unit 110. Preferably refill unit 110 has replaceable power source 120 affixed thereto; however, in some embodiments, the replaceable power source 120 is provided separately with the refill unit 110. In either case, however, the replaceable power source 120 is provided with and removed with the refill unit 110.

System circuitry 130 also includes a bank of capacitors 145 and capacitor control circuitry 146 in circuit communication with processor 132. The bank of capacitors 145 and capacitor control circuitry 146 is in circuit communication with replaceable power source interface receptacle 144 and actuator drive 148. Replaceable power source interface receptacle 144 is configured to receive and/or otherwise electrically couple with replaceable power source 120 when a refill unit 110 is inserted in the dispenser 100.

During operation, when a refill unit 110 is inserted into dispenser 100, processor 132 and capacitor control circuitry 146 cause the bank of capacitors 145 to charge in parallel. In one exemplary embodiment, there are three capacitors. In some embodiments the capacitors are oversized for the required power to power the motor and associated gearing 150 to dispense a dose of foam. Oversized capacitors are preferably charged to a level that is less than the rated voltage of the capacitors. Because the bank of capacitors 145 is charged to less than full capacity, there is less discharge in the capacitors when they are idle for a period of time. In some embodiments, the capacitors are charged to less than about 50% of their full capacity. In some embodiments, the capacitors are charged to less than about 75% of their full capacity. In some embodiments, the capacitors are charged to less than about 90% of their full capacity.

When the processor 132, through object sensor 142, determines that an object is within the dispense zone, the processor 132 causes the capacitor control circuitry 146 to place the capacitors 145 in series to provide power to switching device 182, which provides modulated power to the actuator drive circuitry 148 to power the motor and associated gearing 150 to operate foam pump 114. Once a dose has been dispensed, processor 132 checks the charge on the capacitors 145. If the charge is below a threshold, the processor 132 causes the capacitor control circuitry 146 to charge the capacitors 145. The capacitors 145 are charged in parallel.

In some embodiments, the processor 132 monitors the amount of fluid left in the refill unit 110. The processor 132 may monitor the amount of fluid by detecting the fluid level, for example, with a level sensor, with a proximity sensor, with an infrared detection, by counting the amount of doses dispensed and comparing that to a total number of dispenses for the refill unit or the like. When the processor 132 determines that the refill unit 110 is empty, or close to being empty, the processor 132 causes the replaceable power source 120 to charge the capacitors 145 up to their maximum charge, or to charge the capacitors 145 up until the replaceable power source 120 is completely drained or drained as far as possible. Thus, when the refill unit 110 and replaceable power source 120 is removed, as much energy as possible has been removed from the replaceable power source 120.

Although the exemplary dispenser 100 is shown and described with capacitors as a power source, other types of power sources may be used, such as, for example, rechargeable batteries. Additional exemplary dispensers as well as more detail on the circuitry for the touch free dispenser described above is more fully described and shown in U.S. patent application Ser. No. 13/770,360 titled Power Systems for Touch Free Dispensers and Refill Units Containing a Power source, filed on Feb. 19, 2013 which is incorporated herein by reference in its entirety.

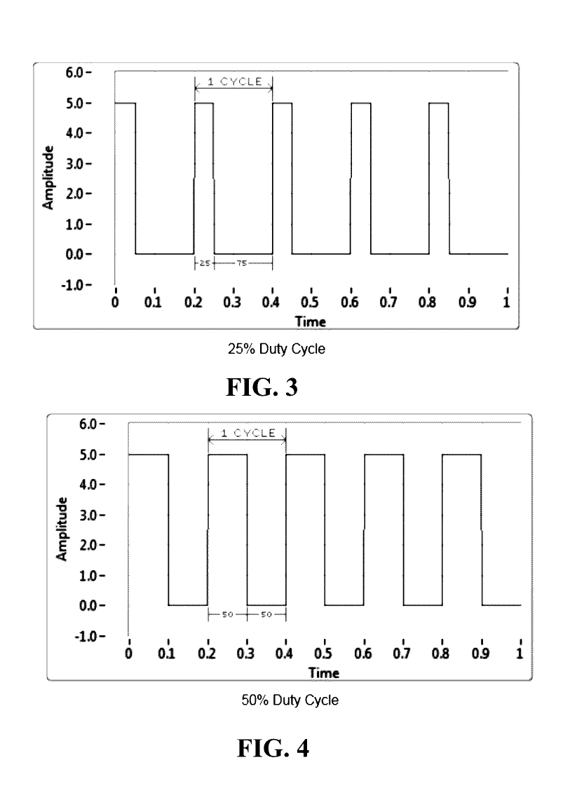

FIG. 3 illustrates an exemplary waveform output by pulse width modulation circuitry 180 and switching device 182. In this exemplary embodiment, the voltage is 5 volts and one cycle is 0.2 seconds. The wave form represents a 25% duty cycle, which means that the motor receives voltage pulses that are approximately 0.05 seconds long at about 5 volts followed by 0.15 seconds of substantially no voltage. Similarly, FIG. 4 illustrates another exemplary waveform output by pulse width modulation circuitry 180 and switching device 182. In this exemplary embodiment, the voltage is 5 volts and one cycle is 0.2 seconds. The waveform represents a 50% duty cycle, which means that the motor receive voltage pulses that are approximately 0.1 seconds long at about 5 volts followed by 0.1 seconds of substantially no voltage. Any suitable duty cycle may be used. Typically, the duty cycle is greater than a 10% duty cycle. In addition, the duty cycle need not be consistent for an entire dispense cycle. For example, if a dispense cycle is 1 second, the wave form may start out at a 25% duty cycle and increase to, for example, a 90% duty cycle as the load increases, and drop back down to a 25% duty cycle as the load decreases.

Duty cycles may be selected based on noise levels of the dispensers. For example, the dispenser may have a high noise level at above a 95% duty cycle and below a 40% duty cycle. Accordingly, in some embodiments, the duty cycle (or duty cycles) may be selected to be within the range for a quieter operation.

FIG. 5 illustrates the charge level for a capacitor bank. When the capacitor bank is fully charged at e₁ the time to dispense a product (under a “standard” operation without pulse width modulation) is time t₁, however, when the energy level is at e₂, the time required for an actuation cycle is time t₂, at an energy level of e₃, the actuation cycle takes time t₃. As can be seen, the charge level of the device greatly changes the time it takes to dispense a dose of fluid. A similar pattern develops when batteries are used, however, the increase in cycle time tends to occur over greater time periods.

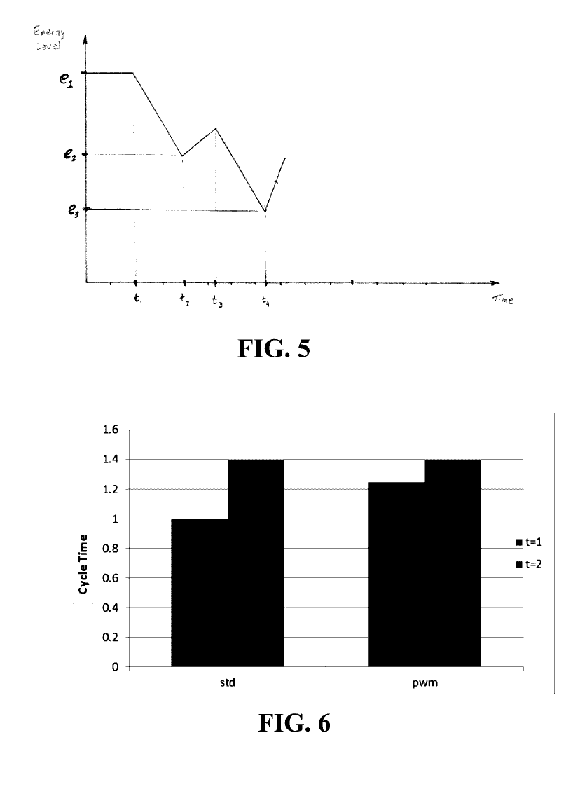

Pulse width modulation circuitry 180 allows cycle times to be standardized. FIG. 6 illustrates two cycle times for a dispenser under standard operation, without pulse width modulation and two cycle times for the dispense using pulse width modulation circuitry. As can be seen, under standard operation, the first dispense cycle requires only 1 second to dispense a dose of fluid, however, the second dispense cycle requires 1.4 seconds to dispense a dose of fluid. Thus, the change in dispense cycle times is about 0.4 seconds. Using pulse width modulation, the power is limited during the first dispense cycle by pulsing on and off the voltage applied to the dispenser motor during the first cycle, which results in a dispense time of slightly greater than 1.2 seconds. During the second dispense cycle, the pulse width modulation pulses on and off the voltage applied to the dispense cycle with a higher duty cycle than during the first dispense resulting in a dispense time of 1.4 seconds. Thus, with pulse width modulation, the difference in dispense times between is less than 0.2 seconds. Accordingly, in one embodiment, pulse width modulation circuitry reduced the differences in cycle time significantly. As used herein, the higher the duty cycle, the wider the pulse duration is. For example, a 100% duty cycle means that the voltage is constantly applied. A 90% duty cycle means that the voltage is turned on for 90% of the cycle and off for 10% of the cycle. A 40% duty cycle means that the voltage is turned on for 40% of the cycle and off for 60% of the cycle.

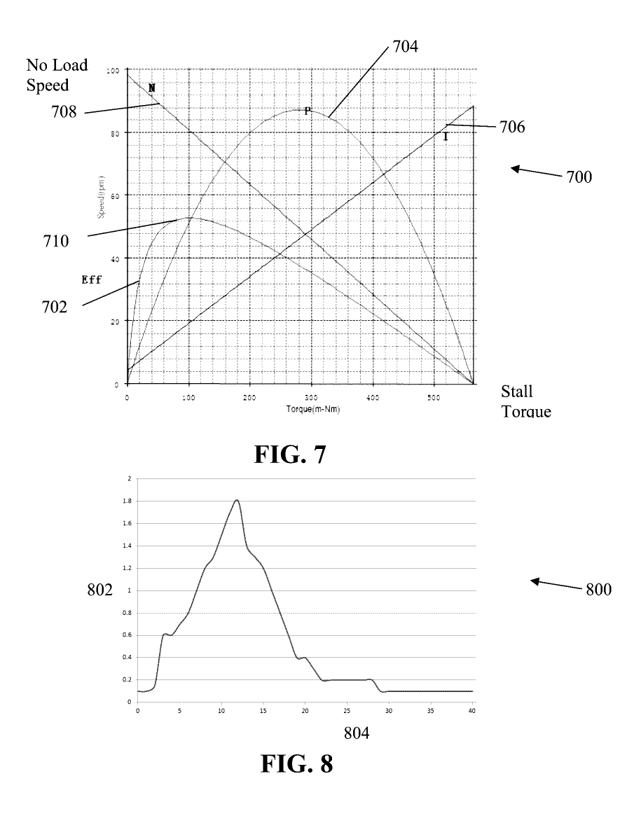

In some embodiments, the pulse width modulation circuitry 180 attempts to reduce the overall power needed and energy needed for the dispense cycle. When dispense power and energy values are reduced, it increased battery life of the device or enables reduction of battery capacity needed for the dispenser. Both of which lead to lower operating costs. FIG. 7 is a speed torque curve 700 for a DC motor. The graph has a motor efficiency curve 702, a max power curve 704, a motor current curve, and a motor speed curve 708. As can be seen from the graph, the peak efficiency of the motor is at a speed 46 rpm (710). Accordingly, the pulse width circuitry may be varied based on the load. For example, if the load is light, a lower duty cycle may be used in an attempt to limit the speed of the motor to about 46 rpm. As the load increases, the duty cycle increases in an attempt to maintain the speed. As the load again decreases, the duty cycle decreases to limit the speed of the motor to about 46 rpm.

FIG. 8 is an exemplary load verses actuator cycle displacement curve 800, with the load 802 along the y-axis and the displacement 804 along the x-axis. As can be seen from the curve, the motor is lightly loaded at first, more heavily loaded and then is unloaded and then coasts to the end of the cycle. The pulse width modulation circuitry can match the load-displacement curve to the efficiency curve of the motor to efficiently drive the dispenser actuator. One exemplary method of applying pulse width modulation is to limit the power delivered to the motor when the displacement is between 0 and 2 and between 23 and 28 and increasing the power between 2 and 23. Thus, the duty cycles between 1 and 2 and between 23 and 28 are lower than the duty cycle between 2 and 23. In some embodiments, the duty cycle between 2 and 23 is 100%, in some embodiments the duty cycle between 2 and 23 is 95% or less. In some embodiments, the duty cycle gradually increases from 2 to about 12 and gradually decreases from 12 to about 23.

The pulse width modulation circuitry 180 may be configured differently based on the type of material being dispensed. In some embodiments a selector switch is included that allows a user to identify the type of product to be dispensed. Varies types of products may be dispensed, liquid soap, liquid sanitizer, foam soap, foam sanitizer and the like. In some embodiments interface receptacle 144 includes circuitry for reading information form refill unit 110. The information may be communicated directly to processor 132 or through capacitor circuitry 146 to processor 132. Different pulse width frequency modulation schemes may correlate to the different types of fluid. For example, if a liquid soap is being dispensed, the pulse width modulation may be at a lower duty cycle, such as for example 50%, than that required for foam soap dispensing, which may have a higher duty cycle, such as for example 75%.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. It is not the intention of the applicant to restrict or in any way limit the scope of the appended claims to such detail. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order in which the steps are presented to be construed as required or necessary unless expressly so stated.

I/we claim:

1. A soap, sanitizing or lotion dispenser comprising:
a housing;
a receptacle for receiving a container for holding a soap, sanitizing or lotion;
a container of fluid;
a pump secured to the container;
a power source;
a motor;
an actuator coupling the motor to the pump; and
pulse width modulation circuitry in circuit communication with the power source and the motor;
wherein movement of the actuator one actuation cycle dispenses a dose of fluid;
wherein the pulse width modulation circuitry provides a plurality of voltage pulses to the motor to move the actuator one actuation cycle.

2. The soap, sanitizing or lotion dispenser of claim 1 wherein the duty cycle of the voltage pulses is a function of the charge level of the power source.

3. The soap, sanitizing or lotion dispenser of claim 2 wherein the duty cycle is increased as the charge level of the power source decreases.

4. The soap, sanitizing or lotion dispenser of claim 1 wherein the duty cycle is adjusted to limit the speed of the motor to its optimal speed point.

5. The soap, sanitizing or lotion dispenser of claim 1 wherein the duty cycle is increased through a first portion of the actuation cycle and are decrease through a second portion of the actuation cycle.

6. The soap, sanitizing or lotion dispenser of claim 1 wherein the duty cycle is a function of the motor efficiency curve.

7. The soap, sanitizing or lotion dispenser of claim 1 wherein the power source comprises one or more capacitors.

8. A soap, sanitizing or lotion dispenser comprising:
a housing;
a receptacle for receiving a container for holding a soap, sanitizing or lotion;
a power source;
a motor;
an actuator coupled to the motor; and
pulse width modulation circuitry in circuit communication with the power source and the motor;
wherein movement of the actuator one actuation cycle dispenses a dose of fluid;
wherein the pulse width modulation circuitry provides a plurality of voltage pulses to the motor to move the actuator one actuation cycle.

9. The soap, sanitizing or lotion dispenser of claim 8 wherein the duty cycle is a function of the charge level of the power source.

10. The soap, sanitizing or lotion dispenser of claim 9 wherein the duty cycle is increased as the charge level of the power source decreases.

11. The soap, sanitizing or lotion dispenser of claim 8 wherein the duty cycle is adjusted to limit the speed of the motor to its optimal speed point.

12. The soap, sanitizing or lotion dispenser of claim 8 wherein the duty cycle is increased through a first portion of the actuation cycle and are decrease through a second portion of the actuation cycle.

13. The soap, sanitizing or lotion dispenser of claim 8 wherein the duty cycle is a function of the motor efficiency curve.

14. The soap or sanitizing dispenser of claim 8 wherein the power source comprises one or more capacitors.

15. A soap, sanitizing or lotion dispenser comprising:
a housing;
a receptacle for receiving a container for holding a soap, sanitizing or lotion;
a power source;
a motor; and
pulse width modulation circuitry in circuit communication with the power source and the motor;
wherein the pulse width modulation circuitry provides a plurality of voltage pulses to the motor to dispense a fluid.

16. The soap, sanitizing or lotion dispenser of claim 15 wherein the duty cycle is a function of the charge level of the power source.

17. The soap, sanitizing or lotion dispenser of claim 16 wherein the duty cycle is increased as the charge level of the power source decreases.

18. The soap, sanitizing or lotion dispenser of claim 15 wherein the duty cycle is increased through a first portion of the actuation cycle and are decrease through a second portion of the actuation cycle.

19. The soap, sanitizing or lotion dispenser of claim 15 wherein the duty cycle is a function of the motor efficiency curve.

20. The soap, sanitizing or lotion dispenser of claim 15 wherein the power source comprises one or more capacitors.
